(19) United States
(12) Patent Application Publication
(10) Pub. No.: US 2016/0159566 A1
(43) Pub. Date: Jun. 9, 2016

(54) Structural Panel for a Double Wall Storage Tank

(71) Applicant: Chemposite-Zhongshan FRP Ltd., Zhongshan (CN)

(72) Inventors: Zhongyue LIU, Zhongshan City (CN); Zhen Wei Zheng, Zhongshan City (CN)

(73) Assignee: Chemposite-Zhongshan FRP Ltd., Zhongshan (CN)

(21) Appl. No.: 14/955,733

(22) Filed: Dec. 1, 2015

(30) Foreign Application Priority Data
Dec. 3, 2014 (CA) 2873013

(51) Int. Cl. B65D 90/02; B29D 22/00

(52) U.S. Cl. CPC B65D 90/028; B29D 22/003

(57) ABSTRACT

A structural panel for insertion in a void of a double wall vessel. The panel includes a sectional sheet and a plurality of spaced dome-shaped projections extending perpendicularly from a local face from the sheet. The panel provides an interconnected interstitial space between layers that may serve as a drainable space for leak detection when used in vessels but also provides maximized structural rigidity in the length and width direction.

### FIELD

The invention relates to the field of storage tank products and in particular to a double wall containment system utilizing a three dimensional panel in between an inner and outer wall of a liquid storage tank.

### BACKGROUND

Composite materials have various properties that make them useful for engineering applications. Generally, these materials offer qualities of strength and stiffness in tension, flexure and shear. The useful characteristics of various building products are somewhat dependant on their geometric shape. Materials such as steel and other metals are available in various standard shapes that optimize the desired characteristics. For example, to maximize flexural strength and stiffness it is best to concentrate material in thin surfaces opposed to each other running in the direction of flexure. The shapes commonly made reflect the necessities of the manufacturing process. Common shape includes linear cross sections such as steel I-beams or channels. These shapes are assembled in various ways to suit the intended end use.

In the simplest application, the current application relates to a panel shaped to provide a hollow section in the length and the width direction by extending an array of features in the both directions between thin faces for permanent service performance. Several methods to achieve this are well known; for example, in aerospace, honeycomb shapes are bonded between thin structural sheets of metal or composite materials. Another method is to use structural foam, or other proprietary materials between the two interfaces as seen in the composite industry. All these solutions have drawbacks in that the core space is filled with material which limits its application. Additionally, the core space in the prior art, is vulnerable to water intrusion and delamination. Furthermore, the bonding between the structural layers and the core material may be limited and inconsistent.

In any containment or transfer system, chemical liquids or gas pose a hazard to the environment when the containment and/or transfer system fails. It is especially critical if the system is buried underground and the leakage is hard to contain or detect. New government regulations have imposed the use of double-wall construction for all underground or above ground vessels that carry potentially hazardous chemicals. Additionally required are detection systems within the double-wall to warn of any leakage or failure.

The current invention seeks to resolve the problems found in the prior art by providing an interconnected interstitial space between layers that may serve as a drainable space for leak detection when used in double-wall vessels but also provides maximized structural rigidity in the length and width direction. The interconnected interstitial has numerous possible uses in addition to the primary function of rigidity. It may be used to detect leaks as noted, but also to provide a fillable space for the insert of other materials or media such as liquid, foam or solid shapes for added reinforcement and protection.

Other objects of the invention will be apparent from the description that follows.

### SUMMARY OF THE INVENTION

According to the present invention there is provided a structural panel for insertion in a void of a double wall vessel. The panel includes a sectional sheet and a plurality of spaced dome-shaped projections extending perpendicularly from a local face from said sheet.

The projections may be configured to provide structural shear rigidity to the double-wall vessel. The projections may also be configured to provide an interstitial space in the double-wall vessel for leak detection when the panel is inserted in the void of the double-wall vessel. The projections may also be configured to provide an interstitial space in the double-wall vessel for containment when the panel is inserted in the void of the double-wall vessel.

The projections may include a wall extending from the sheet and may connect to a base. The top may be parallel to the local face and the wall may extend from the sheet in the form of a dome with an initial radius of 48 mm and a base for connection to the adjacent sheets.

The dome-shaped projections may be hollow up to said base and may be regularly spaced along said sheet. The regular spacing of the dome-shaped projections in a width of the sheet may b 115 mm and the regular spacing of the dome-shaped projections in a length of the sheet may be 125 mm. In the alternative, the dome-shaped projections may be irregularly spaced along the sheet.

The dome-shaped projections may have a base and an open top at the sheet. The each of the dome-shaped projections may have a diameter of 96 mm at the open top, a base diameter of 60 mm, a depth of 36 mm from the open top to the base and a radius of 48 mm as measured from the open top to the wall.

The projections may all extend from the same side of the sheet.

According to another embodiment of the present invention there is provided a structural panel for insertion in a void of a double-wall vessel. The panel may include a sectional sheet and a plurality of spaced dome-shaped projections extending perpendicularly from a face of the sheet.

The projections may be configured to provide structural shear rigidity to the double-wall vessel when the panel is inserted in the void of the double-wall vessel. The projections may also be configured to provide an interstitial space in the double-wall vessel for leak detection when the panel is inserted in the void of the double-wall vessel. The projections may also be configured to provide an interstitial space in the double-wall vessel for containment when the panel is inserted in the void of the double-wall vessel.

According to yet another embodiment of the present invention there is provided a method of producing a structural panel. The method may include providing a sectional sheet, which may be placed through a roller, and forming a plurality of spaced dome-shaped projections extending perpendicularly from a local face from the sheet.

Forming the plurality of spaced dome-shaped projections may include placing the sheet over a mould which may be inserted into a machine press.

According to yet another embodiment of the present invention there is provided a method of increasing the structural integrity of a double-wall vessel. The method may include providing a sectional sheet having a plurality of spaced dome-shaped projections extending perpendicularly from a local face from the sheet. Bonding means may be provided to affix the sectional sheet inside a void of the double-wall vessel. The sectional sheet may then be allowed sufficient time to bond inside a void of the double-wall vessel.

The bonding means may include an adhesive, a weld, a mechanical fastener and/or other equivalent means.

According to yet another embodiment of the present invention there is provided a use of a structural panel for increasing the structural integrity of a double-wall vessel. The structural panel may include a sectional sheet and a plurality of spaced dome-shaped projections extending perpendicularly from a local face from the sheet.

According to yet another embodiment of the present invention there is provided a use of a structural panel for leak detection in a double-wall vessel.

The structural panel may include a sectional sheet and a plurality of spaced dome-shaped projections extending perpendicularly from a local face from the sheet.

According to yet another embodiment of the present invention there is provided a use of a structural panel for containment in a double-wall vessel. The structural panel may include a sectional sheet and a plurality of spaced dome-shaped projections extending perpendicularly from a local face from the sheet.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which

FIG. 1 a perspective view of the preferred embodiment of the invention;

FIG. 2 is a top plan view of FIG. 1.;

FIG. 3 is a side view along line 2-2 of FIG. 2;

FIG. 4 is a perspective view of the invention installed in a double wall vessel;

FIG. 5 is an exploded perspective view of the invention between two walls; and

FIG. 6 is a plan view of the invention sandwiched between two walls.

### DETAILED DESCRIPTION OF THE INVENTION

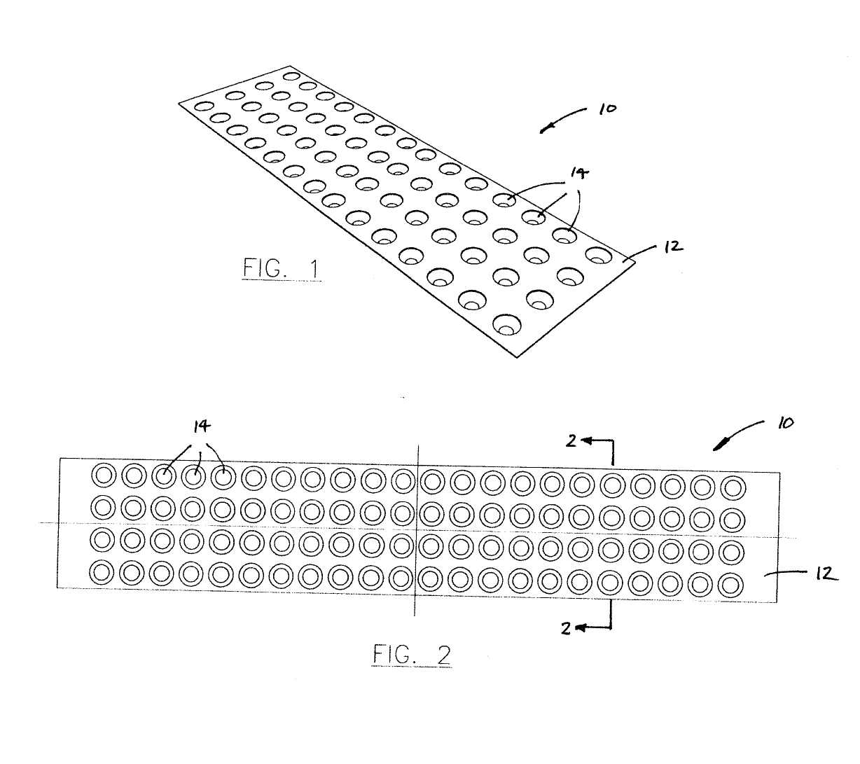

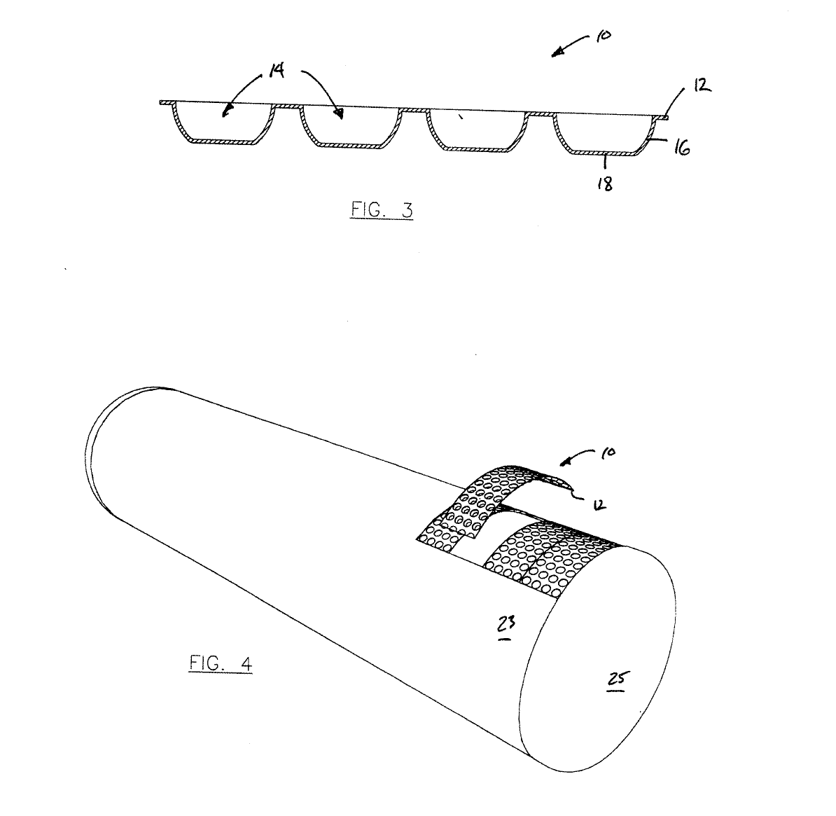

Referring to FIGS. 1, 2 and 3 a structural panel 10 is depicted. Panel 10 includes a sectional sheet 12 and a plurality of spaced dome-shaped projections 14 extending perpendicularly from a local face from sheet 12. Here, projections 14 are depicted as extending from the same side of sheet 12, however, as those skilled in the art will appreciate, projections 14 may extend from either side of sheet 12 depending upon the application. Each dome-shaped projection 14 may be shaped and sized to meet structural requirements and as those skilled in the art will appreciate, the dome-shaped projection is not limited to those depicted.

Panel 10 is commonly formed in a continuous process and supplied in sheet format to be used as a sandwich core material in composite products. Here, a sectional sheet is provided via conventional means and a plurality of spaced dome-shaped projections are formed that extend perpendicularly from a local face from the sheet.

Each of projections 14 include a wall 16 extending from sheet 12 and connecting with a base 18. As depicted, base 18 runs parallel to the local face and wall 16 extends from sheet 12 in the form of a dome with a common radius, an open top and a flat base. Sheet 12 and projections 14 may have a wall thickness of preferably approximately 3.5 mm.

Projections 14 are preferably hollow up to base 18 and are regularly spaced along sheet 12. Preferably, the regular spacing of projections 14 in a width of sheet 12 is 115 mm centre-to-centre and the regular spacing of projections 14 in a length of sheet 12 is 125 mm centre-to-centre. In the alternative, projections 14 may be irregularly spaced along sheet 12.

As depicted, base 18 is circular in shape, but it is also contemplated that base 18 may be a non-infinite polygon in shape, for example, a pentagon. As depicted, projections 14 are preferably shaped to resemble a dome with a base 18 and an open top at sheet 12. Preferably, the dome has a diameter of 96 mm at the open top, a base diameter of 60 mm, a depth of 36 mm from the open top to the base and a common radius of 48 mm as measured from the center point of the open top 18 to wall 16.

Panel 10 may primarily be used as a sandwich core material for double wall tanks, pipe and covers to increase the product strength and act as a secondary detection system for any leakage in the products. Thus, although sheet 12 is depicted as a flat sheet, sheet 12 may be any configurable shape depending upon its application. Panel 12 will generally be bonded in between any composite plates or sheets either through custom fabrication or manufacturing processes.

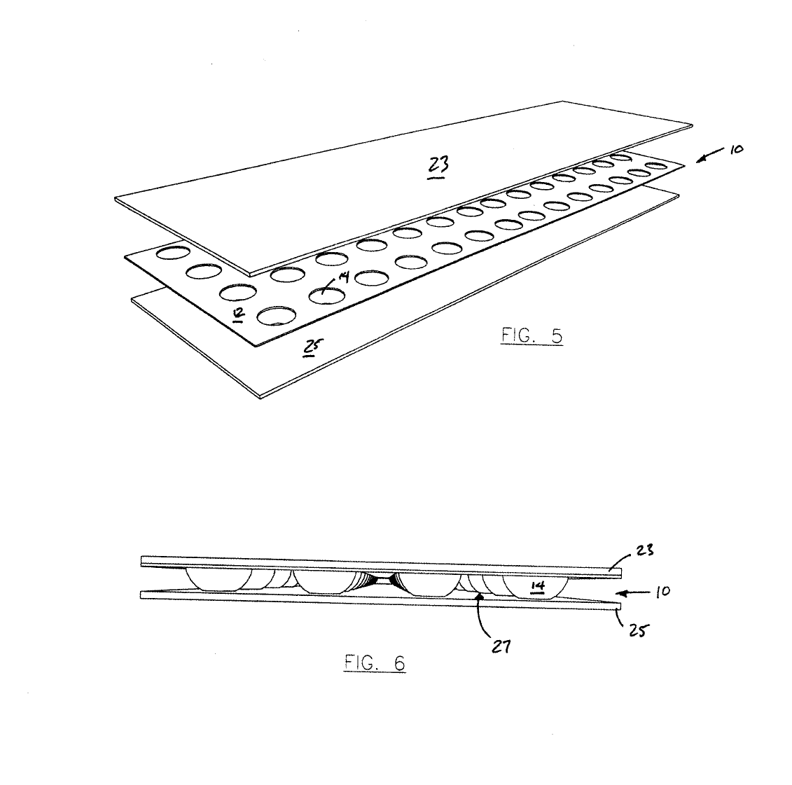

Referring to FIGS. 4, 5 and 6 panel 10 is primarily be used as a sandwich core material for double wall tanks, pipe and covers to increase the product strength and act as a secondary detection system for any leakage in the products. Thus, although sheet 12 is depicted as a flat sheet, sheet 12 may be any configurable shape depending upon its application. Panel 12 will generally be bonded in between any composite outer 23 and inner 25 walls or sheets either through custom fabrication or manufacturing processes. The bonding means may include an adhesive, a weld, a mechanical fastener and/or other equivalent means.

As those skilled in the art will appreciate, projections 14 are configured to also provide structural shear rigidity to a double-wall vessel. The exact shape and spacing of projections 14 will be dependent upon the particular application and the dimensions and shapes described and illustrated are only preferred embodiments of the invention.

Projections 14 may also be configured to provide an interstitial space 27 in the double-wall vessel for leak detection when panel 10 is inserted in the void of the double-wall vessel having composite outer 23 and inner 25 walls. Projections 14 may also be configured to provide an interstitial space 27 in the double-wall vessel for containment when panel 10 is inserted in the void of the double-wall vessel.

Panel 10 with its uneven or bump shape design, allows liquid to pass through and fill in any cavity in between the sandwich section of the tank or pipe in order to monitor the condition. The section will be filled with liquid and connected to a sensor for an early warning system. In case of any leakage due to exterior or interior failure, the liquid level will change and trigger the sensor. This panel design can also act as a structural sandwich core material to increase the strength of the equipment and reduce the material usage in production.

Panel 10 is designed to eliminate the older technique in utilizing 3D fabric. Product 10 has increased the production efficiency of any double wall product since the material is supplied in a prefabricated sheet and not in raw material form as a fiberglass fabric. Its shape has more contact or bonding area than any other sandwich material such as honeycomb core that is commonly used in the structural application. Its solid panel with its engineered shape and size has enhanced the strongest structural form available according to the product requirement. This will increase the flexibility in the future design in double wall products for added strength and/or leak prevention.

It will thus be seen that a new and novel structural panel has been illustrated and described and it will be apparent to those skilled in the art that the preferred and alternative embodiments have been described in some detail but that certain modifications may be practiced without departing from the principles of the invention.

What is claimed is:

1. A structural panel for insertion in a void of a double wall vessel, the panel comprising:
a sectional sheet; and
a plurality of spaced dome-shaped projections extending perpendicularly from a local face from said sheet.

2. The panel of claim 1 wherein when said dome-shaped projections are configured to provide structural shear rigidity to the double-wall vessel.

3. The panel of claim 2 wherein said dome-shaped projections are configured to provide an interstitial space in the double-wall vessel for leak detection of gasses or liquids contained in the double-wall vessel.

4. The panel of claim 2 wherein said dome-shaped projections are configured to provide an interstitial space in the double-wall vessel for containment of gasses or liquids contained in the double-wall vessel.

5. The panel of claim 1 wherein each of said dome-shaped projections comprise a wall extending from said sheet and connecting to a base, said base being parallel to said local face, said wall extending from said sheet with an initial radius of 48 mm and a base for connection to an adjacent sheet or a structure.

6. The panel of claim 5 wherein said dome-shaped projections are hollow up to said base.

7. The panel of claim 1 wherein said dome-shaped projections are regularly spaced along said sheet.

8. The panel of claim 7 wherein said regular spacing of said dome-shaped projections in a width of said sheet is 115 mm and said regular spacing of said projections in a length of said sheet is 125 mm.

9. The panel of claim 1 wherein said dome-shaped projections are irregularly spaced along said sheet.

10. The panel of claim 1 wherein each of said dome-shaped projections have a diameter of 96 mm at an open top, a base diameter of 60 mm, a depth of 36 mm from said open top to said base and an inside radius of 48 mm as measured from a center point of said open top to said wall.

11. The panel of claim 1 wherein said dome-shaped projections all extend from the same side of said sheet.

12. A method of producing a structural panel for insertion in a void of a double-wall vessel, comprising:
providing a sectional sheet; and
forming a plurality of spaced dome-shaped projections extending perpendicularly from a local face from said sheet.

13. The method of claim 12 wherein forming said plurality of spaced dome-shaped projections comprises placing said sheet over a mould.

14. The method of claim 13 further comprising placing said sheet and mould into a machine press.

15. The method of claim 12 further comprising applying conventional fabrication techniques with contact molding, vacuum infusion and resin transfer molding.

16. A method of increasing the structural integrity of a double-wall vessel comprising:
providing a sectional sheet, said sheet having a plurality of spaced dome-shaped projections extending perpendicularly from a local face from said sheet;
providing bonding means;
affixing said sectional sheet inside a void of the double-wall vessel with said bonding means; and
allowing said bonding means to bond said sectional sheet inside said void of the double wall vessel.

17. The method of claim 16 wherein said bonding means comprises an adhesive.

18. The method of claim 16 wherein said bonding means comprises a weld.

19. The method of claim 16 wherein said bonding means comprises a mechanical fastener.
